(19) United States
(12) Patent Application Publication
(10) Pub. No.: US 2009/0097873 A1
(43) Pub. Date: Apr. 16, 2009

(54) INTERMEDIATE ROLLER FOR SENSING TEMPERATURE OF PASSING SURFACES

(75) Inventor: David K. Biegelsen, Portola Valley, CA (US)

Correspondence Address: FAY SHARPE / XEROX - PARC, 1228 EUCLID AVENUE, 5TH FLOOR, THE HALLE BUILDING, CLEVELAND, OH, 44115, US

(73) Assignee: PALO ALTO RESEARCH CENTER INCORPORATED

(21) Appl. No.: 11/873,134

(22) Filed: Oct. 16, 2007

(51) Int. Cl. G03G 15/20

(52) U.S. Cl. 399/69

(57) ABSTRACT

A temperature sensing system for use in an electrographic printing machine senses temperature on a surface of a moving member. An intermediate roller is placed in operative contact with the surface of the moving member at a first location. A temperature sensor is then placed in operative connection with the intermediate roller at a location distanced and/or isolated from the moving member. A bias member is placed in operative contact with the temperature sensor to provide a force to the temperature sensor, resulting in the temperature sensor being biased against the intermediate roller, the temperature sensor thereby sensing the surface temperature of the moving member indirectly through the intermediate roller.

### BACKGROUND

The present application relates to an image reproduction machine such as an electrophotographic copying machine or printer and, more particularly, to a temperature sensing/controlling system of the image reproduction machine.

In a typical electrophotographic printing process, a photoconductive member is charged to a substantially uniform potential so as to sensitize the surface of the member. The charged portion of the member is exposed to selectively dissipate charges on the irradiated areas. This records an electrostatic latent image on the member. After the electrostatic latent image is recorded, the latent image is developed by bringing a developer material, such as toner, into contact with the latent image. The toner powder image is then transferred from the photoconductive member to a copy sheet. The toner particles are heated to permanently affix the powder image to the copy sheet.

In order to fix or fuse the toner material, it is necessary to elevate the temperature of the toner material to a point at which constituents of the toner material coalesce and become tacky. This action causes the toner to flow to some extent onto the fibers or pores of the copy sheet. Thereafter, as the toner material cools, solidification of the toner material occurs causing the toner material to be bonded firmly to the copy sheet.

One approach to thermal fusing of toner material images onto the copy sheet has been to pass the copy sheet with the unfused toner images thereon between a pair of opposed roller members at least one of which is internally heated. During operation of a fusing system of this type, the copy sheet to which the toner images are electrostatically adhered is moved through the nip formed between the rolls with the toner image contacting the heated fuser roll to thereby affect heating of the toner images within the nip.

In order to insure a fuser functions at desired operating temperatures, a temperature sensing/controlling system including a thermistor or some other type temperature sensing device is employed. Conventionally, the temperature sensing/controlling device or devices physically engage the surface of the fuser member which most commonly comprises a pair of roller members. One such fuser utilizes an internally heated fuser roll. As will be appreciated, the heated fuser member may be heated using an external source.

The physical engagement of the temperature sensor/controller to a cylindrical roller, such as a fuser roller results in a friction, such as a sliding friction, on the surface of the cylindrical roller. Such friction causes wear on the surface of the roller and leads in one instance to printing artifacts and necessitates replacement of the roller or other parts.

Following is a discussion of prior art, incorporated herein by reference, which may bear on the patentability of the present application. In addition to possibly having some relevance to the question of patentability, these references, together with the detailed description to follow, may provide a better understanding and appreciation of the present concepts.

U.S. Pat. No. 4,821,062 granted to Katoh et al. on Apr. 11, 1989 discloses a heat fixing device which includes a temperature sensing element and temperature control element which are integrally combined.

U.S. Pat. No. 5,019,692 granted to Nbedi et al. on May 28, 1991 discloses a thermostatic device including a rotatable roller mountable in rolling engagement with a moving surface.

U.S. Pat. No. 5,281,793 granted to Gavin et al. on Jan. 25, 1994 discloses an apparatus with a resistance reducing mechanism, interposed between the apparatus and a moving object or roller, for reducing frictional resistance between the apparatus and the moving object.

U.S. Pat. No. 5,475,200 granted to Amico et al on Dec. 12, 1995 discloses a thermistor assembly wherein a wear resistant member is loosely disposed about a thermistor in contact with a thermistor bead such that it is between the bead and a heated fuser member and completely surrounds the components of the thermistor. The wear resistant member is in the form of a strap or tape having an opening adjacent one end through the opposite end is insertable.

U.S. Pat. No. 5,666,593 granted to Amico et al. on Sep. 9, 1997 discloses a temperature sensor with one or more Resistance Temperature Detector (RTD) sensors embedded in a polyimide material.

### BRIEF DESCRIPTION

A temperature sensing system for use in an electrographic printing machine senses temperature on a surface of a moving member. An intermediate roller is placed in operative contact with the surface of the moving member at a first location. A temperature sensor is then placed in operative connection with the intermediate roller at a location distanced and/or isolated from the moving member. A bias member is placed in operative contact with the temperature sensor to provide a force to the temperature sensor, resulting in the temperature sensor being biased against the intermediate roller, the temperature sensor thereby sensing the surface temperature of the moving member indirectly through the intermediate roller.

### BRIEF DESCRIPTION OF THE DRAWINGS

FIG. 1 is a cross-sectional view of a heat sensing device of the prior art;

FIG. 2 is a side-view of another embodiment of a heat sensing device of the prior art;

FIG. 3 is a cross-sectional view of one of the heat sensors of FIG. 2;

FIG. 4 is a schematic view of a heat sensing device of the present application;

FIG. 5 is a side view of the system of FIG. 4;

FIG. 6 is a schematic view of another embodiment of a heat sensing device of the present application;

FIG. 7 is a schematic view of still another embodiment of a heat sensing devise of the present application; and

FIG. 8 is a schematic view of a temperature sensing system of the present application used in connection with a belt system.

### DETAILED DESCRIPTION

FIG. 1 is a cross-sectional view of a prior art temperature sensing device 10 for an image reproduction machine such as an electrophotographic copying machine or printer.

The temperature sensing system 10 of FIG. 1 is shown in use with a moving member such as a cylindrical heat roller (fuser roller) 12 coated with a heat resistive resin such as Teflon or the like. Within the cylindrical roller 12, an inner heater 14 is provided for generating heat to the cylindrical roller 12. A second roller (not shown) coated with, for example, a silicone rubber is forced against the cylindrical roller 12. A copied paper passes through the clearance between the cylindrical roller 12 and the second roller, during which a toner image is heat fixed onto the copied paper.

Provided at the peripheral surface of the cylindrical roller 12, as part of temperature sensing system 10, is a temperature sensing element 16, such as a thermistor, for sensing the temperature of the heat fixing device.

A temperature control element such as a thermostat 20 is integrally combined with the thermistor 16. The thermostat 20 is for preventing an abnormal temperature increase in the fixing device. The thermostat 20 is secured on a plate 22 for stressing the thermostat 20 and the thermistor 16 toward the surface of the cylindrical roller 12. The plate 22 is supported by a body frame 24 of the image reproduction machine and can electrically move toward the cylindrical roller 12. A pair of springs 24 are provided for forcing the combination of the thermistor 16 and the thermostat 20 toward the cylindrical roller 12.

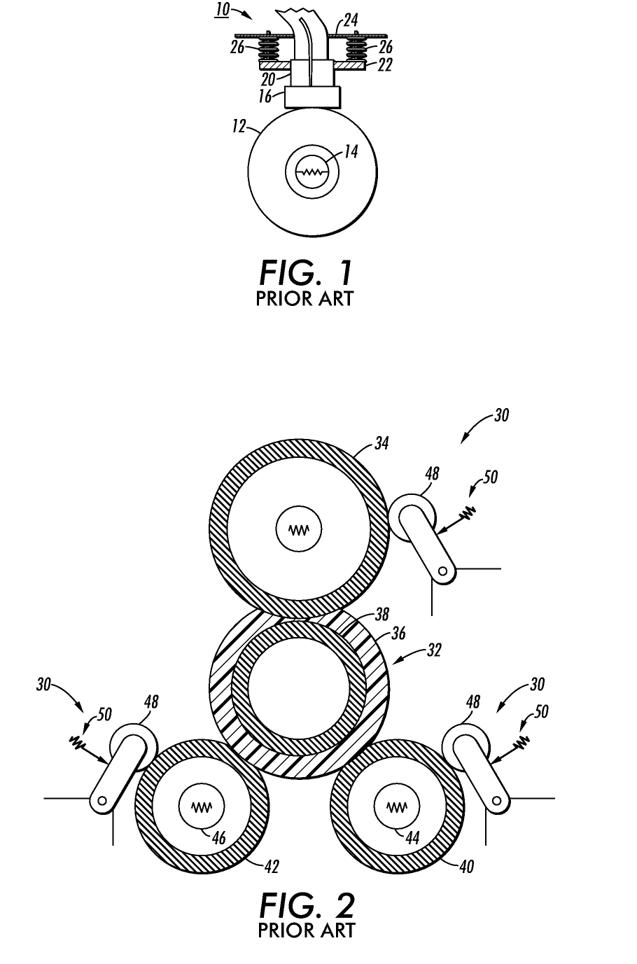

FIG. 2 illustrates another embodiment of an existing temperature sensing system 30 of a copying machine or printer including moving members such as a fusing roller 32 and a pressure roller 34 (not shown in FIG. 1). The rollers or moving members typically have surfaces which have good release characteristics and may be coated with silicone oil to prevent offset of toner onto either roller. Pressure roller 34 is shown as a hard metallic roller which is internally heated. Fusing roller 32 has a somewhat compliant outer layer or layers 36 made of a material such as silicone rubber or other material which is compliant enough to form a nip of some width with pressure roller 34. Outer layer or layers 36 are positioned on a core 38 which generally is of aluminum, glass or similar hard material. Because the compliant material layer or layers 36 do not conduct heat as well as metallic pressure roller 34, the surface of fusing roller 32 is heated by a pair of metallic heating rollers or moving members 40 and 42 which are heated internally by lamps 44 and 46.

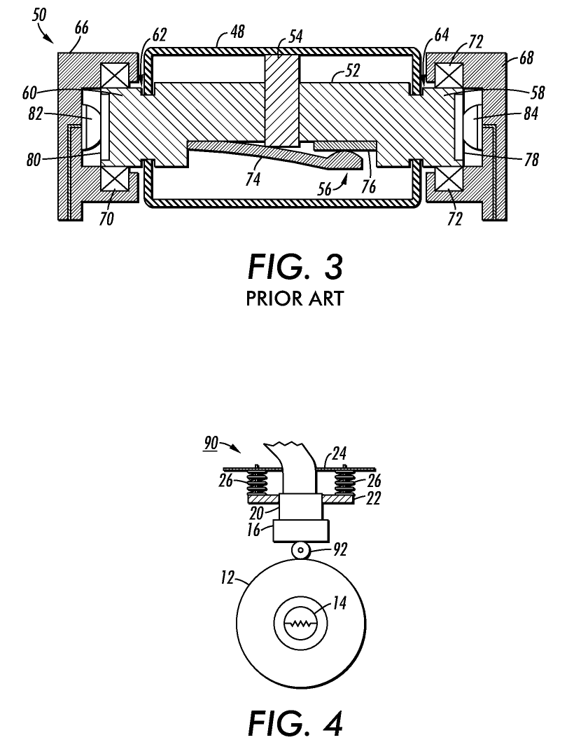

With continuing attention to FIG. 2 temperature sensing system 30, includes a roller type temperature sensor 48 carried on carrier 50, and where sensor 48 is configured with internal components to sense and control the temperature of rollers 34, 40 and 42. Turning to FIG. 3, shown is an internal view of the roller temperature sensor 48, along with carrier 50. The configuration includes heat insulative support 52, along with a ceramic pin 54 positioned in a hole in support 52, with an end which rests directly against the inner surface of roller 48. The other end of ceramic pin 54 engages part of a switch 56 held by pin 54 in an open condition in FIG. 3. Support 52 includes end extensions 58 and 60 which have cylindrical outer bearing surfaces 62 and 64 coaxial with roller 48.

Support arms 66 and 68 include ball bearings 70 and 72 which engage bearing surfaces 62 and 64 on extensions 58 and 60 and hold support 52 for rotation with respect to arms 66 and 68.

Switch 56 is made up of first and second switching members 74 and 76 which are held in slots in support 52 in positions in which they are resiliently urged toward a closed position. The ends of members 74 and 76 away from their contacts include contact elements 78 and 80 positioned on outside lateral faces of extensions 58 and 60. Although contact elements 78 and 80 are shown as separate metallic elements in electrical contact with switch members 74 and 76, they could, of course, be made from single pieces with members 74 and 76 appropriately folded. Arms 66 and 68 contain arm contacts 82 and 84 resiliently urged by means not shown into contact with contact members 78 and 80.

Turning to FIG. 4, a temperature sensing system 90 according to the present application is provided and configured to eliminate dragging type friction known to damage moving members, such as cylindrical roller 12. In the embodiment of FIG. 4, temperature sensing system 90 includes elements similar to the device of FIG. 1, including temperature sensing element 16, which may be a thermistor or other appropriate component for sensing the temperature of cylindrical roller 12. In addition, thermistor 16 may be attached to thermostat 20. Thermostat 20 is secured to plate 22 in a manner to stress thermostat 20 and thermistor 16 toward the surface of cylindrical roller 12. Plate 22 is supported by body frame 24. An additional configuration in connection with temperature sensing system 90 of FIG. 4 is the inclusion of intermediate, rotatable cylindrical element 92 interposed between temperature sensing element 16 and the surface of cylindrical roller 12. As may be appreciated from the foregoing discussion of FIG. 1, undesirable artifacts and other damage may be caused to the surface of cylindrical roller 12 when the temperature sensing element 16 is in contact to the surface of cylindrical roller 12, as movement of cylindrical roller 12 results in a rubbing contact of temperature sensing element 16 with the moving surface, causing wear on the surface of cylindrical roller 12.

By interposing intermediate roller 92, this rubbing contact, which causes sliding friction, is replaced with a rolling friction, resulting in much less stress being placed upon the surface of cylindrical roller 12. Thus, in this embodiment the temperature sensor, e.g., thermistor 16, is placed in an arrangement to contact the intermediate roller 92 and to measure the temperature of the surface of cylindrical roller 12 indirectly through intermediate roller 92. The arrangement of FIG. 4 also illustrates temperature sensor 16 and cylindrical roller 12 are distanced and/or isolated from each other.

This embodiment uses a simple configuration of the intermediate cylindrical roller. There are no internal mechanisms or components within intermediate roller 92. Rather, the transmission of the sensed temperature is undertaken by others of the previously noted components.

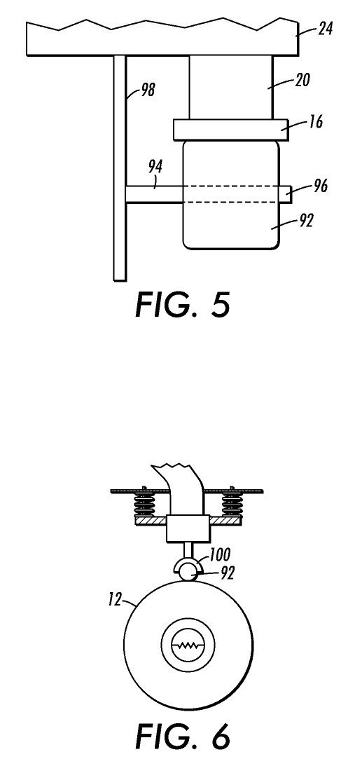

A benefit of this embodiment therefore is the simplicity with which it may be incorporated into existing systems as a retrofit. For example, as shown in FIG. 5, the intermediate roller 92 may be integrated into the system by a simple shaft 94 and pin 96 arrangement, where the intermediate roller 92 is held in place by its interconnection to shaft 94 extending from a bracket 98.

Turning to FIG. 6, illustrated is another embodiment of the concepts according to the present application. In this embodiment, the temperature sensor 100 is formed to match the circumference of the intermediate roller 92.

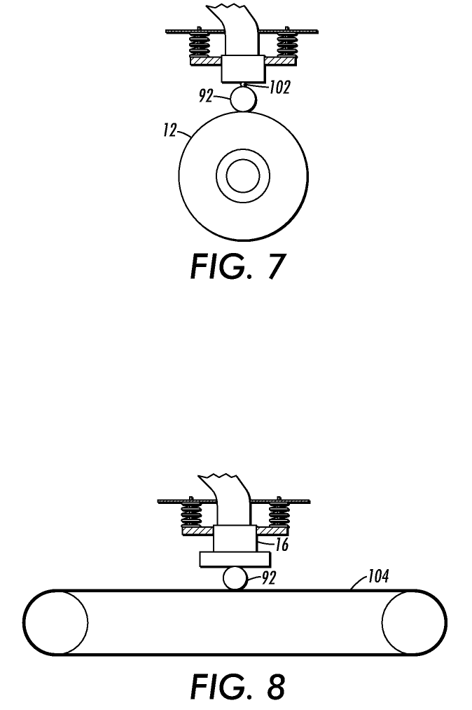

Turning to FIG. 7, depicted is a further embodiment where the temperature sensor 102 is a bead type heat sensing component. In this design, bead portion 102 is placed in contact with the intermediate roller 92.

Turning to FIG. 8, depicted is still a further embodiment of the present application, wherein the temperature sensing device 16 is used to sense the temperature of a moving belt 104, indirectly through intermediate roller 92.

It is to be appreciated that the embodiments shown in the Figures are not intended to limit the concepts of the present application, but use of an intermediate cylindrical roller to transform a system imparting the sliding friction on a moving member during a sensing operation to a rolling friction may be implemented in a number of embodiments. As also mentioned, due to the simple construction of the system, for example, the uncomplicated design of the intermediate roller 92, retrofitting of existing systems is simplified, as well as incorporation of the present components into existing designs of newly manufactured systems.

It is also to be appreciated that intermediate roller 92 may be composed of a number of different materials, including a plastic coated with an outer surface of metal, a ceramic roller, or a roller with a metal interior having a silicon outer surface, among others. Whichever materials are used, they would preferably permit heat transferred from the moving surface of the machine, e.g., cylindrical roller 12, to be measured indirectly through the heat absorbed by intermediate roller 92. It is to be appreciated that in some instances the heat or temperature of the intermediate roller 92 may be a percentage of the heat or temperature on the surface of cylindrical roller 12. In these cases, the percentage may be obtained through simple trial-and-error testing. However, many materials which may be used to configure the intermediate roller 92 will cause a de minimus heat loss. In these designs the heat or temperature sensed on the intermediate roller 92 may be directly used. Also the temperatures of interest in many uses are within a range and the exact temperature of cylindrical roller 12 is not needed. Additionally, intermediate roller 92 may be configured in a cylindrical form, spherical form, or other configuration, which provides rolling friction to the surface of the cylindrical roller 12, or other appropriate roller.

It is also to be appreciated while the foregoing discussion has focused on the use of the temperature sensing systems of the present application in connection with an electrophotographic device and fuser rollers of such a device, the concepts are equally applicable to other rollers within a copy machine or printer.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. In a photocopy or printing machine including at least one moving member whose temperature is to be measured, a temperature sensing system to sense a temperature on a surface of the moving member, the temperature sensing system comprising:
an intermediate roller in operative contact with said surface of the moving member;
a temperature sensor with a matching curvature as the intermediate roller in operative contact with the intermediate roller at a location distanced from the moving member; and
a bias member in operative contact with the temperature sensor to provide a force to the temperature sensor, resulting in the temperature sensor being biased against the intermediate roller, wherein the temperature sensor senses the surface temperature of the moving member indirectly through the intermediate roller.

2. The system of claim 1 wherein the intermediate roller is a retrofit for an existing photocopy or printing machine.

3. The system of claim 1 wherein the intermediate roller is a metal plated plastic roller.

4. The system of claim 1 wherein the intermediate roller is a ceramic roller.

5. The system of claim 1 wherein the intermediate roller is configured to create a rolling friction on the surface of the moving member.

6. The system of claim 1 wherein the intermediate roller contains no internal components.

7. The system of claim 1 wherein the moving member is a cylindrical roller.

8. The system of claim 1 wherein the moving member is a belt system.

9. The system of claim 1 wherein the temperature sensor is a thermistor.

10. (canceled)

11. The system of claim 1 wherein the temperature sensor is a bead thermistor.

12. A method for detecting a temperature on a surface of a moving member of a photocopy machine, the method comprising:
contacting an intermediate roller at a first location to the surface of the moving member;
contacting the intermediate roller to a temperature sensor, the temperature sensor with a matching curvature as the intermediate roller and distanced from the moving member;
transferring heat from the moving member to the intermediate roller; and
sensing the temperature of the surface of the moving member by the temperature sensor indirectly through the intermediate roller.

13. The method of claim 12, wherein a rolling friction is applied to the moving member.

14. The method of claim 12, wherein the intermediate roller is configured with no internal moving parts.

15. A temperature sensing system for sensing the temperature of a linearly or rotatory translating surface, the temperature sensing system comprising:
an arcuate temperature sensor configured to sense a temperature of the linearly or rotatory translating surface; and
an intermediate roller with a matching curvature as the arcuate temperature sensor interposed between the linearly or rotatory translating surface and temperature sensor, configured to transfer heat from the linearly or rotatory translating surface to the temperature sensor for indirect sensing of the temperature of the linearly or rotatory translating surface.

16. The system according to claim 15, wherein the linearly or rotatory translating surface is a belt fuser.

17. The system according to claim 15, wherein the linearly or rotatory translating surface is a fuser roller.

18. The system of claim 1 wherein the moving member is configured to house an inner heater.

19. The system of claim 18 wherein the temperature sensor and inner heater are electronically connected to a thermostat.

20. The method of claim 12 wherein the moving member is configured with an inner heater controlled by a thermostat electronically connected to the temperature sensor.

21. The system of claim 15 wherein the moving member is configured to house an inner heater element controlled by a thermostat electronically connected to the temperature sensor.
